(19) United States
(12) Patent Application Publication
(10) Pub. No.: US 2005/0133651 A1
(43) Pub. Date: Jun. 23, 2005

(54) Fishing reel gear mechanism coating

(76) Inventor: Chung Cheung, Kwai Chung (HK)

Correspondence Address: ALIX YALE & RISTAS LLP, 750 MAIN STREET, SUITE 1400, HARTFORD, CT, 06103, US

(21) Appl. No.: 10/699,389

(22) Filed: Oct. 31, 2003

(51) Int. Cl. A01K 89/00

(52) U.S. Cl. 242/263

(57) ABSTRACT

The invention involves a gear mechanism in a fishing reel having coatings applied to the gears. The coating promotes the reduction of friction between a gear couple and improvement of wear and/or corrosion resistance when compared with conventional systems. The invention includes the application of one or multi layers of substances on a surfaces of a gear couple. The gear couple may be either the driving gear or driven gear in the couple and one of the gears of the couple has an outermost golden layer, which includes the element gold.

### BACKGROUND OF THE INVENTION

The present invention relates generally to fishing reels of the type having gear mechanisms that transmit and redirect rotational force, and more particularly to coatings of gears that reduce friction between gear surfaces and that improve the life span of gears.

Typically, in a spinning fishing reel there is a gear mechanism for the transmission and redirection of rotational force used to operate the reel. The gear mechanism generally includes a set of gears relationally positioned to allow interaction between the gear surfaces. The operating characteristics and life span of the gears are generally important factors to be considered when developing a fishing reel mechanism. This is because deterioration of the gears results in poor reel performance. In addition, operating characteristics that detract from the use of a fishing reel are attributed, at least in part, to the jiggling force generated from gear interactions.

Gear wear is a concern because fishing reel gear mechanisms are subjected severe operational conditions due to sudden forces being applied to them. For instance, when a fish is on the fishing line, the need to quickly operate the reel and the intense forces applied by the fish via the line need to be considered. The durability of the gears directly relates to the function of the reel since any deterioration in the gears results in such things as gear backlash and/or different than normal operational characteristics. Another concern for designers of fishing reel mechanisms is corrosion. Corrosion is especially a problem for fishing reels that are subjected to contact with sea water or with substances having corrosive properties.

Previous gear mechanisms utilized special coatings on the gear surfaces and/or the application of lubricants onto the gears in an effort to reduce the friction generated from operation of a gear couple. A coating used conventionally is a polytetrafluoroethylene (Teflon) coating. The Teflon is coated on one of the gears in a gear couple to reduce the meshing friction of the gears. However, the relatively thick Teflon layer creates problems due to a significant change to the tooth meshing profiles. This profile change leads to excessive mechanical wear and/or noise and vibration. Furthermore, Teflon is not suitable for zinc components due to the high curing temperature requirement of Teflon.

Other gear mechanisms conventionally utilize lubricants or grease at the gear interfaces. However, lubricants or grease are prone to drying out or solidifying over time. Lubricants and grease also entrap particulate material such as sand, grit, or dust. The particulate material then acts, for example, abrasively on the meshing surfaces in a manner that quickly leads to wear, noise, and vibration. Frequent cleaning and replacement of the lubricant is also necessary. Also employed in some mechanisms is a molybdenum bi-sulfide paste or coating that is well known as dry lubricant. However, molybdenum bi-sulfide substance is very expensive, and the lubricating characteristics under low load conditions are unsatisfactory.

### SUMMARY OF THE INVENTION

Briefly stated, the present invention in a preferred form is generally directed toward a gear mechanism in a fishing reel. More particularly, the invention involves a gear mechanism having coatings applied to the gears. The invention generally reduces friction between a gear couple and improves the wear and/or corrosion resistance characteristics of the gears. The invention includes the application of one or multi layers of substances on a surfaces of a gear couple. The coatings may be interchangably located on either the driving gear or driven gear in the couple. One of the gears in the couple has an outermost golden layer, which includes the element gold. An intermediate layer may optionally be present between the golden layer and the gear base surface to improve the adherence of the golden layer to the gear surface. The other gear of the gear couple has a chromium outermost layer, which includes the element chromium. A second optional intermediate layer can also be applied between the chromium layer and the gear base surface to improve the adherence of the chromium layer to the gear.

An object of the invention is to provide a more efficient and trouble free fishing reel operation by improving the corrosion and/or wear resistance of gear mechanisms in fishing reels.

Another object of the invention is to provide layers of chromium and gold in a manner that does not significantly change the tooth profile of the gears.

A further object of the invention is to reduce meshing friction between gears in an efficient and relatively low cost manner so as to prolong the gear life.

### BRIEF DESCRIPTION OF THE DRAWINGS

Other objects and advantages of the invention will be evident to one of ordinary skill in the art from the following detailed description with reference to the accompanying drawings, in which:

FIG. 1 shows a perspective view of a coated fishing reel gear couple which includes a helical-cut worm gear and a helical crown gear consistent with the present invention.

FIG. 2 shows coated spur gears in meshing contact used in a gear couple consistent with the present invention.

FIGS. 3 and 4 show partial sectional views of the coated fishing reel gears consistent with the present invention.

FIG. 5 shows partial sectional view of a gear couple in meshing contact with coated gears consistent with the present invention.

FIG. 6 shows a cutaway view of a fishing reel including a coated gear couple consistent with the present invention.

FIG. 7 is a schematic flow chart to showing a process used to coat a golden layer onto a zinc part consistent with the present invention.

FIG. 8 is a schematic flow chart to illustrate a process to coat a chromium layer onto a brass part consistent with the present invention.

FIG. 9 is a graph showing the effect of the forces associated with prior art gears during operation.

FIG. 10 is a graph showing the effect of the forces associated with coated gears consistent with the present invention during operation.

### DETAILED DESCRIPTION OF THE PREFERRED EMBODIMENT

With reference to the drawings wherein like numerals represent like parts throughout the several figures, a gear mechanism in accordance with the present invention is generally designated by the numeral 10.

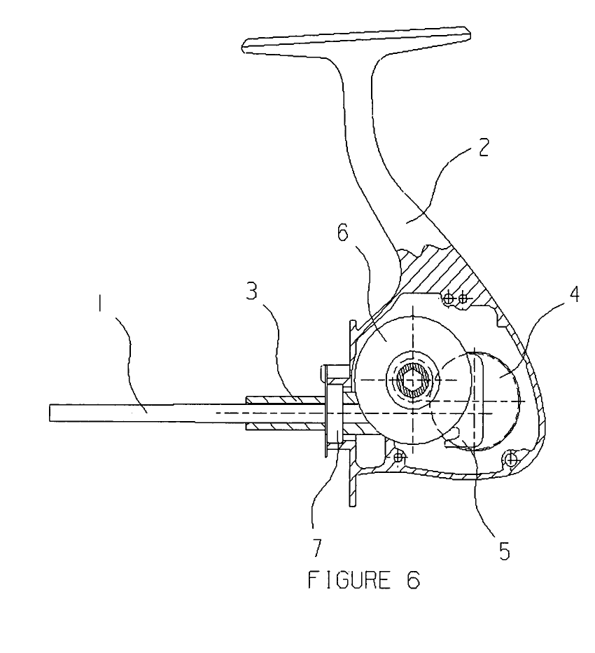

One type of fishing reel that incorporates the invention is a spinning type fishing reel with a rotor mechanism well known in the art as shown in, for example, FIG. 6. The reel has a body 2 which encases, for example, a first gear 4 and a second gear 6. A level wind element 5 may be present which may be driven by the first gear 4. A spindle 1 may be in mechanical contact with the level wind element 5. The spindle 1 moves in a generally fore and aft direction within a guide 7 relative a rotational motion of the first gear 4 and the second gear 6. At the same time the second gear 6 may also mesh with a helical-cut worm gear 3 that may turn a rotor of the fishing reel. Of particular interest to the present invention is the meshing of the first gear 4 and the second gear 6 and/or the meshing of the helical-cut worm gear 3 and the second gear 6.

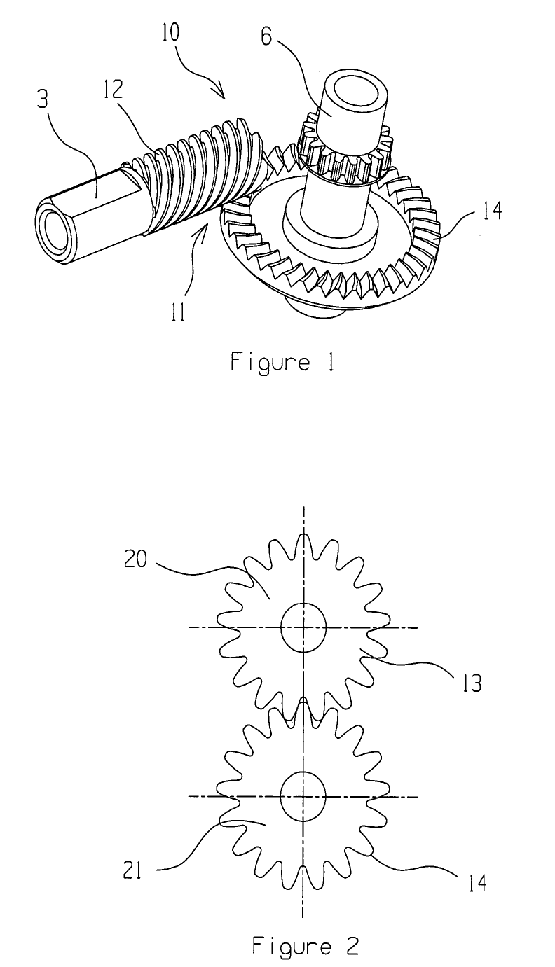

In one embodiment of the invention as shown in, for example, FIG. 1, the gear mechanism 10 includes a gear couple 11 formed by a helical-cut worm gear 3 and a helical crown gear 8. The gears used may be any combination of well known gears and include spur gears, crown gears, helical gears, worm gears and the like. Each gear may have base meshing surfaces such as teeth 14, cogs, notches, holes and/or other features used to communicate force from the gear to another element. The gears may be formed of metals such as iron, steel, zinc, copper, bronze, brass, and/or similar material or combinations of materials. The teeth 14 of the gear may be formed by molding, hobbing or the like.

A golden layer 41 having at least some elemental gold as a constituent of the layer comprises the outmost layer. The golden layer 41 may be disposed on a gear base surface 12. A chromium outmost layer 31 may be disposed on the gear base surface 14 of the second gear in the gear couple. The chromium layer 31 includes at least the element chromium. Both the golden layer 41 and chromium layer 31 may be coated onto the gears using a variety of methods. For example, the layers may be deposited using electrical, mechanical and chemical means well known in the art. The layers may be formed so as to create a uniform or varied thickness on surfaces of the gears. For example the golden layer 41 may be formed to a substantially uniform thickness of 0.005 mm over the surface of the gear 21.

The golden layer 41 may in one embodiment of the invention be disposed on the helical crown gear 8 while the chromium outmost layer is on the helical-cut worm gear 3. Thus, it can be seen that the two layers may be used interchangeably with regard to the gears in the gear couple.

For example, in one embodiment of the invention as shown in FIG. 2, the gears used are spur gears 13. The golden layer 41 is on the driving gear 20, and a chromium layer 31 is disposed on the surface of the driven gear 21. However, it is understood that the golden layer 41 may instead be disposed on the driven gear 21 while the chromium outmost layer 31 is disposed on the driving gear 20.

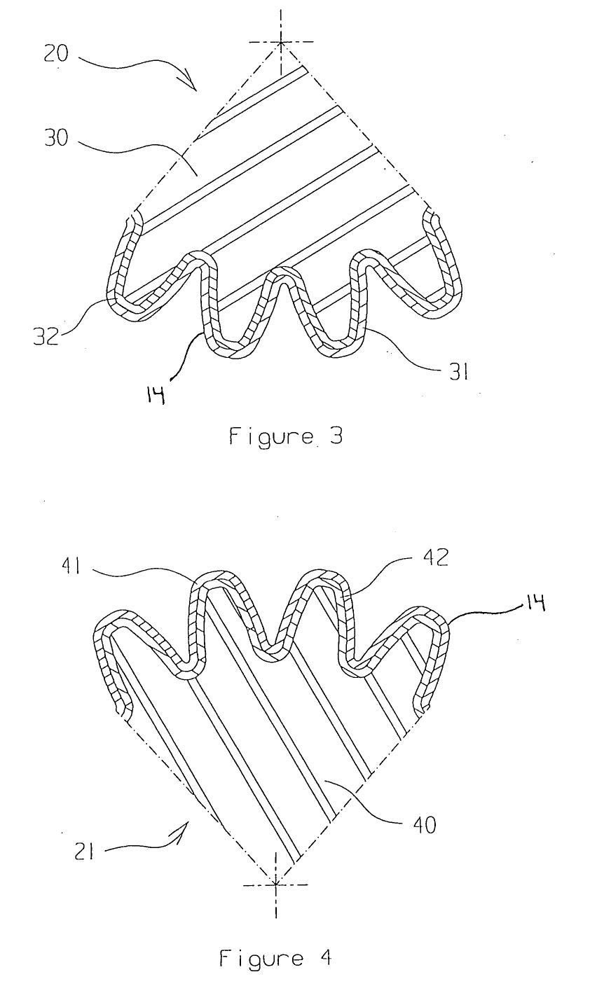

In one embodiment of the invention as shown in FIG. 3 and FIG. 4, the driving gear 20 and the driven gear 21 have an intermediate layer 32 between the driving gear base material 30 and the chromium layer 31. The intermediate layer 32 functions to increase the adhesion of the chromium layer 31 to the driving gear base material 30. As an example, the intermediate layer 32 may be composed of at least nickel. The use of this intermediate layer 32 is optional and in some cases there can be more than one intermediate layer. The driven gear 21 may also have an intermediate layer 42 between the driven gear base material 40 and the golden layer 41. The intermediate layer 42 functions to improve the adhesion of the golden layer to the driven gear base material 40. The intermediate layer 42 may be composed of any of several appropriate materials. For example, the intermediate layers 42 may be formed of cyanide copper, or acid copper sulfate. The driven gear 21 may also have more than one intermediate layer 42.

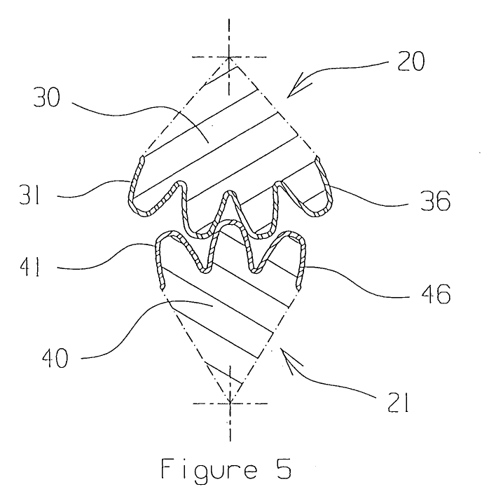

In one embodiment of the invention as shown in, for example, FIG. 5, a gear couple is in meshing contact. The meshing contact is between a first gear surface, such as the driven gear golden layer 41 and the second gear surface such as the driving gear chromium layer 31. The meshing contact of these layers reduce the meshing friction that is normally associated with a gear pair not having such layers. The reduction in friction, among other things, reduces the amount of gear wear. In addition, because the chromium layer 31 and the golden layer 41 substantially surround both gears of the gear couple, the effects of gear damage due to corrosion are reduced or eliminated. This is due to the inert characteristic of the chromium and gold found in the layers.

The driving gear 20 or the driven gear 21 in the couple is coated with a golden outermost layer 41. The gear meshed with the driven gear is coated with a chromium outermost layer 31. In addition, an intermediate layer 42 may be present between the golden layer 41 and the gear surface and/or there may be an intermediate layer 32 between the chromium layer 31 the gear surface of the second gear in the couple. The intermediate layers may have compositions well known in the art for improving adherence of the golden 41 and chromium 31 layers to the gear material. For example, the gears of the gear couple may be made substantially of zinc with the intermediate layer providing adherence between the gear surface and the outer layer. In some cases the intermediate layer may comprise one or more layers having similar or varying compositions depending on the desired properties wished to be achieved.

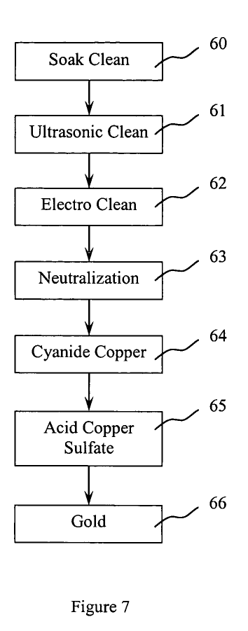

In one embodiment of the invention, a golden layer 41 is on a zinc gear. A variety of different methods can be used, for instance in one process as shown in, for example, FIG. 7 a golden layer 41 is coated onto a zinc gear in several steps. Between each of the steps of the process the part being coated may be fully rinsed with, for example, water.

According to the condition of the zinc gear, the zinc gear is degreased using a soak clean 60 wherein the gear is immersed in a suitable degreasing solution. The gear may then be rinsed and then ultrasonically cleaned 61. At this step the gear may be placed in an ultrasonic cleaner. The gear may then be rinsed and then electro cleaned 62. Further suitable cleaning methods may be added and/or used in place of these steps. The cleaning may be followed by an acid dipping which is preferred to neutralize 63 any of the alkaline substance or substances used during the cleaning of the gear. Two intermediate layers may then be applied. The first intermediate layer 42 may be a cyanide copper layer 64 and the second intermediate layer 42 may be an acid copper sulfate layer 65. Either or both these intermediate layers are coated onto the zinc gear to enhance the adhesive ability of the golden layer 41 to the base zinc surface. These intermediate layers also protects the zinc alloy from erosion which might be caused by the gold plating 66. Finally, gold alloy is applied in the gold plating 66 step, for instance the gold may be applied by electroplating the zinc gear. It is also understood that after every step, the part may be fully rinsed with water.

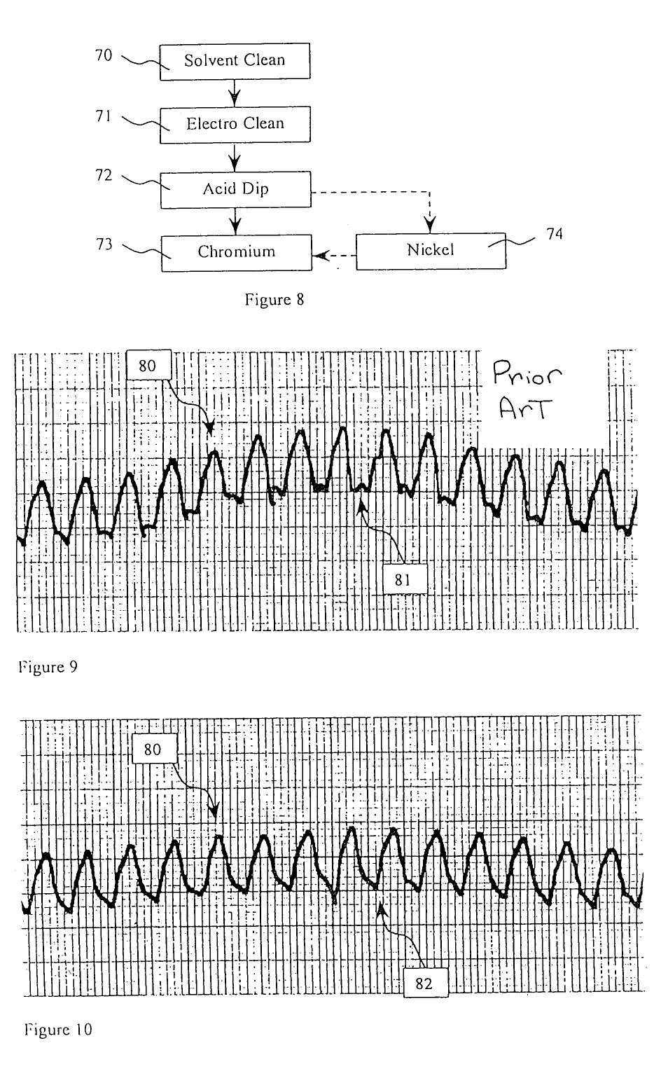

In one embodiment of the invention, a chromium layer is coated onto, for instance, a brass gear. Although different methods can be used, one method is shown in FIG. 8. According to the condition of the brass gear, the gear is cleaned in a suitable solvent 70. The gear may then be rinsed and then placed into an electro cleaner for an electro clean 71. Further suitable cleaning methods may be added or used in place of these steps. The cleaning may be followed by an acid dipping 72. An intermediate layer may then be applied. This layer may be a nickel layer 74. This nickel intermediate layer may be present if the need exists to enhance the adhesive ability of the chromium layer to the gear. However, direct chromium coating onto the brass gear without the nickel intermediate layer is also possible. It is also understood that after every step, the part may be fully rinsed with water.

The forces associated with the operation of, for example, a gear couple can be studied with a double flank composite error tester. The gear couple is set on supporting blocks of the tester. One of the supporting blocks is set on the tester base. The other block, a floating block, is supported by cross springs which allow for change in the center distance between gears in a gear couple. A detector is attached on the floating block which allows movement to be detected. When the gear couple is operated in the tester, variation with regard to the center distance between the gears can be measured by the detector. This variation can be graphed as the gear couple is operated. The meshing condition, tooth to tooth composite error, can thus be measured and graphed. The jiggling force, felt during the operation of a fishing reel, is proportional to the variation. A perfect meshing between gears would result in a graph having a relatively straight horizontal line.

As an illustrative example, FIG. 9 shows a graph of the forces present during the operation of a prior art gear assembly. The jiggling force 81 can be easily seen to correspond to the changing contact point from one tooth 80 to another tooth.

In one embodiment of the invention, the interaction of at least the chromium layer 31 and golden layer 41 on the gears modify the forces present during the operation of a gear assembly. FIG. 10 shows a graph of the forces present during the operation of a coated gear assembly. As can be clearly seen by, at least, the peak appearance and symmetries, the jiggling force 82 is modified advantageously and unexpectedly through the interaction of the coated gear surfaces when compared to the prior art.

While the preferred embodiments have been shown to describe the invention, various modifications and substitutions may be made thereto without departing from the spirit and scope of the invention. Accordingly, it is to be understood that the present invention has been described by way of illustration and not limitation.

1. A fishing reel having a gear couple comprising:
a first gear having a first meshing base, said first meshing base being covered by a first layer which includes the element gold disposed substantially uniformly over the meshing base;
a second gear having a second meshing base, said second meshing base being covered by a second layer which includes the element chromium disposed substantially uniformly over the meshing base,
wherein said first layer and said second layer engage in meshing contact.

2. The fishing reel of claim 1 further including a first intermediate layer disposed between the first meshing base and said first layer.

3. The fishing reel of claim 2 wherein the first intermediate layer is cyanide copper.

4. The fishing reel of claim 2 further including a second intermediate layer disposed between the first meshing base and said first layer.

5. The fishing reel of claim 4 wherein the second intermediate layer is acid copper sulfate.

6. The fishing reel of claim 1 further including a first intermediate layer disposed between the second meshing base and said second layer.

7. The fishing reel of claim 6 wherein the first intermediate layer is nickel.

8. The fishing reel of claim 1 wherein the first layer has a thickness of about 0.005 mm.

9. The fishing reel of claim 1 wherein the first gear is a crown gear.

10. The fishing reel of claim 1 wherein the first gear is a spur gear.

11. The fishing reel of claim 1 wherein the first gear is made from a zinc alloy.

12. A gear couple comprising:
a first gear having a first outer gear layer which includes gold and a second gear having a second outer gear layer which includes chromium; and
said first gear and said second gear being disposed to form a meshing interface between the first gear layer and the second gear layer.

13. The gear couple of claim 12 further including a first intermediate layer between the first gear outer layer and a first gear surface.

14. The gear couple of claim 13 further including a second intermediate layer disposed between the first gear outer and the first gear surface.

15. The gear couple of claim 13 wherein the first intermediate layer is cyanide copper.

16. The gear couple of claim 13 wherein the first intermediate layer is acid copper sulfate.

17. The gear couple of claim 12 further including a first intermediate layer between the second gear outer layer and a second gear surface.

18. The gear couple of claim 12 wherein the first layer has a thickness of about 0.005 mm.

19. The gear couple of claim 12 wherein the first gear is made from a zinc alloy.

20. The gear couple of claim 12 wherein the second gear is made from a brass alloy.
